(19) United States
(12) Patent Application Publication
(10) Pub. No.: US 2008/0030034 A1
(43) Pub. Date: Feb. 7, 2008

(54) MULTIPLE FUNCTION COOKING UTENSIL

(76) Inventor: Nitzan BALACIANO, Arsuf (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/831,993

(22) Filed: Aug. 1, 2007

Related U.S. Application Data
(60) Provisional application No. 60/834,487, filed on Aug. 1, 2006.

(51) Int. Cl. A47J 43/28

(52) U.S. Cl. 294/3

(57) ABSTRACT

The present invention discloses a multi-functional cooking utensil that can be used as a spatula tool, a tongs tool and fork tool where all three tools are integrated as the one utensil that may be useful at the kitchen and/or at the barbecue stand. One part of the utensil may the fork tool comprising of at least two tines and the second part may be the spatula head, wherein the integration of the two parts in a closed position create a spatula, and the open positions may enable using the utensil as a fork and/or a pair of tongs. To enable shifting from one position to another, the handle of the utensil may be made of two flexibly joined parts enabling to separate the tines from one another and/or from the spatula head part, depending upon embodiments of the invention.

### CROSS-REFERENCE TO RELATED APPLICATIONS

This application claims the benefit under 35 U.S.C. §119(e) of U.S. Provisional Patent Application No. 60/834,487 filed on Aug. 1, 2007, the content of which is incorporated by reference herein.

### FIELD OF INVENTION

This invention relates generally to cooking utensils, and more specifically to such devices that efficiently combine a spatula, tongs, and a fork in a single tool.

### BACKGROUND OF THE INVENTION

There are endless options when purchasing kitchen utensils and barbecue tools. When choosing cooking utensils, it is important to choose items that are both functional and efficient. Among the most useful are the spatula (or the turner), the cooking fork, and the tongs.

The spatula, equipped with a wide, flat head, is a versatile utensil used for a multitude of tasks including lifting, removing and flipping cooking food. An important feature of any cooking spatula is the thin front edge that allows the spatula to be inserted easily beneath the food without damaging or piercing the food.

Large cooking forks oftentimes have two or more sharp prongs and are useful both for checking the tenderness of cooking food and for lifting the food from a cooking surface.

Tongs provide an efficient way to handle food that needs to be picked up, turned and removed without piercing the food. This is a particularly useful feature when cooking delicate items such as fish, which may fall apart if not handled gently.

Each of these tools, on its own, is quite useful and, in fact, many consider them to he essential at the grill. However, it is not always efficient to use many separate tools, maybe because one can never find the necessary tool at the necessary time, or maybe simply because the funds or space is lacking. When one is barbecuing, the lack of space is far too often a problem. Trying to juggle multiple tools while also tending to food cooking over hot flames may even be dangerous.

The related ant has attempted to address some of these issues in various manners. Illustrative of such attempts are U.S. Pat. No. 5,934,721 by Walde Armin and US2001045753 by Lewis Davidson W., both of which disclose combined spatula and tong devices where one part of the tongs is a spatula and the other part may either be another spatula or a fork.

### SUMMARY OF THE INVENTION

The present invention discloses a multi-functional cooking utensil that can be used as a turner spatula tool (a substantially flat utensil that allows lifting and turning of edible substances such as meat) and as a tongs tool where all tools are integrated as the one utensil that may be useful at the kitchen and/or at the barbecue stand. One part of the utensil may be a fork tool comprising of at least two tines, the second part may be the spatula head. The integration of the two parts in a meshed position may create a spatula tool, and the unmeshed position may create a tongs tool.

According to embodiments of the invention, the multifunction cooking utensil may comprise two flexibly connected parts, wherein the shape of each part allows the two parts to mesh such that when the utensil is in the closed position, one part sits within the second part and the two parts combine into a single tool that has a substantially flat surface.

According to some embodiments of the present invention, the utensil may have three separate operating positions, enabling to use the utensil in at least three functions: (a) in a first, closed meshed position, the utensil functions as a spatula tool, (b) in a second, open unmeshed vertical position, the utensil functions as a fork, and (c) in a third, open unmeshed horizontal position, the utensil functions as a pair of tongs.

Additionally, the handle of the utensil may bifurcated, comprising of two elongated, relatively narrow first branch and second branch. The handle may terminates on one side in the spatula head connected to the first branch and on the other side in at least two tines connected to the second branch creating the fork tool. The branches may be flexibly joined composing the handle, by means that enable easily shifting from one position to another and from one use of the utensil to another.

Additionally, the first branch and second the second branch may terminate in a plurality of substantially planar parallel strips, wherein said parallel strips may be interposed such that when the multi-function utensil is in the closed position, a spatula tool with a flat, regular surface is created.

### BRIEF DESCRIPTION OF DRAWINGS

The subject matter regarded as the invention will become mole clearly understood in light of the ensuing description of embodiments herein, given by way of example and for purposes of illustrative discussion of the present invention only, with reference to the accompanying drawings, wherein

FIG. 1 is a perspective view of an embodiment of the present invention equipped with an intersecting handle, a spatula head, and tines, in the closed position, wherein the invention may function as a spatula;

FIG. 2 is a front view of the device of FIG. 1, in an opened, horizontal position, wherein the invention may function as a fork;

FIG. 3 is a perspective view of the device of FIG. 1, in the opened, horizontal position, wherein the invention may function as a fork and

FIG. 4 is a perspective view of the device of FIG. 1, in the opened, vertical position, wherein the invention may function as tongs.

FIG. 5 is a perspective view of another embodiment of the present invention equipped with a folded handle, a spatula head, and tines, in the closed position, wherein the invention may function as a spatula.

FIG. 6 is a perspective view of the device of FIG. 5, the opened, horizontal position, wherein the invention may function as a fork.

FIG. 7 is a perspective view of yet another embodiment of the present invention equipped with a folded handle and a plurality of parallel strips, in the closed position, wherein the invention may function as a spatula.

FIG. 8 is a perspective view of the device of FIG. 7, in the opened, vertical position, wherein the invention may function as tongs.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

An embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks,

The term “method” refers to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein,

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

Presented herein is a multiple function cooking utensil 10 that may provide a user with several separate utensils in a single unit that may be efficient, simple and convenient to operate. In accordance with embodiments of the present invention, multi-function utensil 10 may have three positions and three corresponding functions. In the closed position, multi-function utensil 10 may be used as a spatula tool 50 for scooping, flipping, lifting, and other such activities. In the opened, horizontal position, multifunction utensil 10 may be used as a fork tool 60 for lifting or otherwise manipulating, for example, hamburgers. In the opened, vertical position, multi-function utensil 10 may be used as a tongs tool 70 for gripping and lifting, for example, hot dogs.

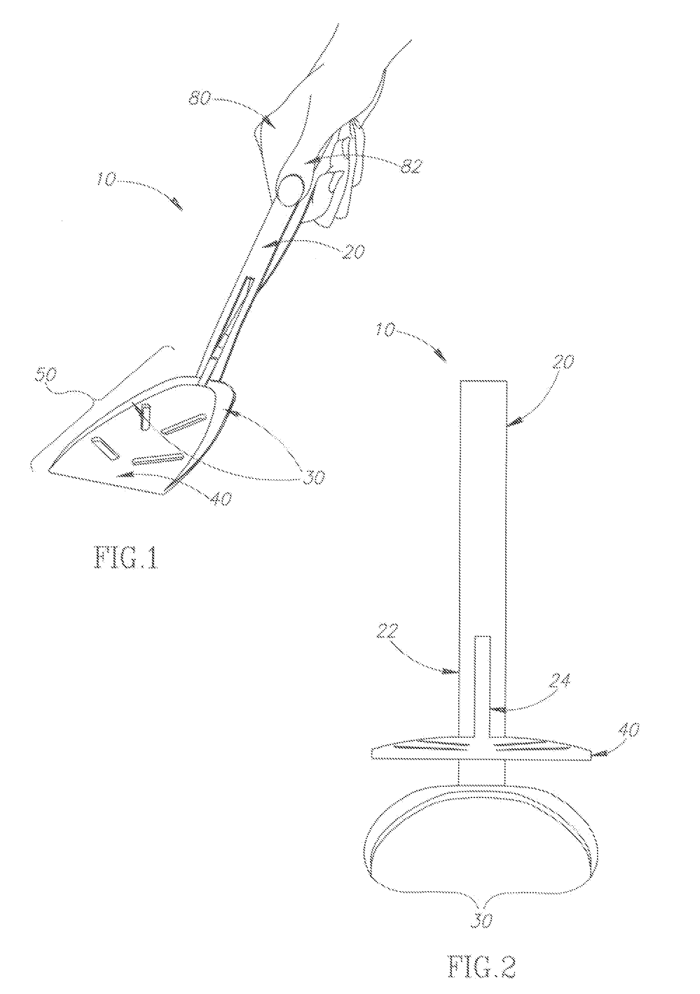

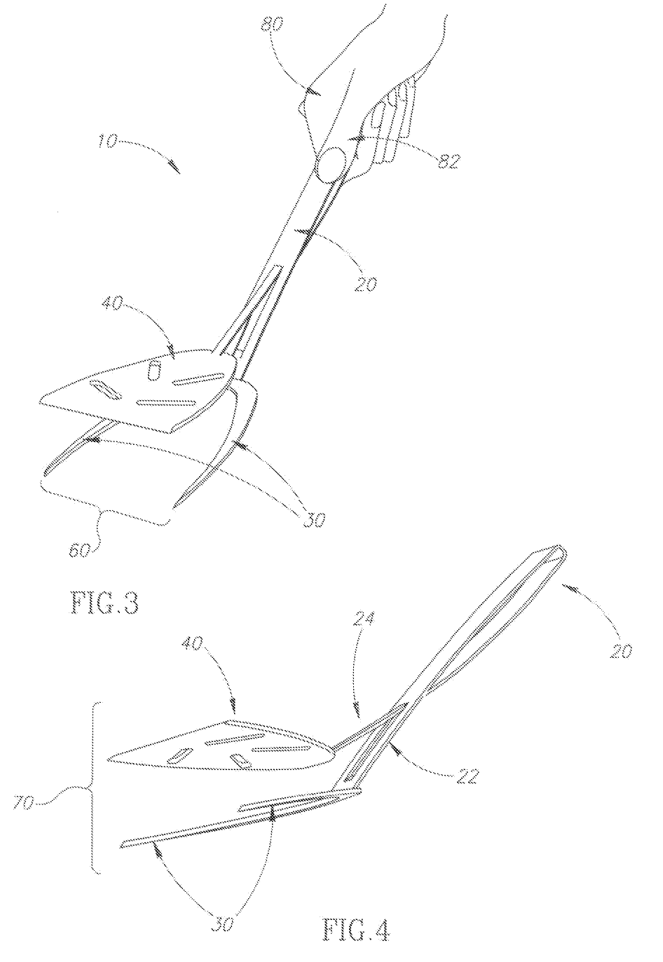

Referring now in detail to the accompanying drawings, wherein FIGS. 1, 2, 3, and 4 describe various views of an embodiment of the present invention, in which multi-function utensil 10 may comprise a handle 20 that may terminate on one side in a spatula head 40 and may terminate on the other in at least two tines 30. Handle 20 provides an area for the user to grasp multi-function utensil 10. According to some embodiments, handle 20 may be bifurcated, comprised of two elongated, relatively narrow branches, a first branch 22 and a second branch 24. Handle 20 may be made of any heat-resistant material such as, for example, stainless steel, wood, plastic, etc.

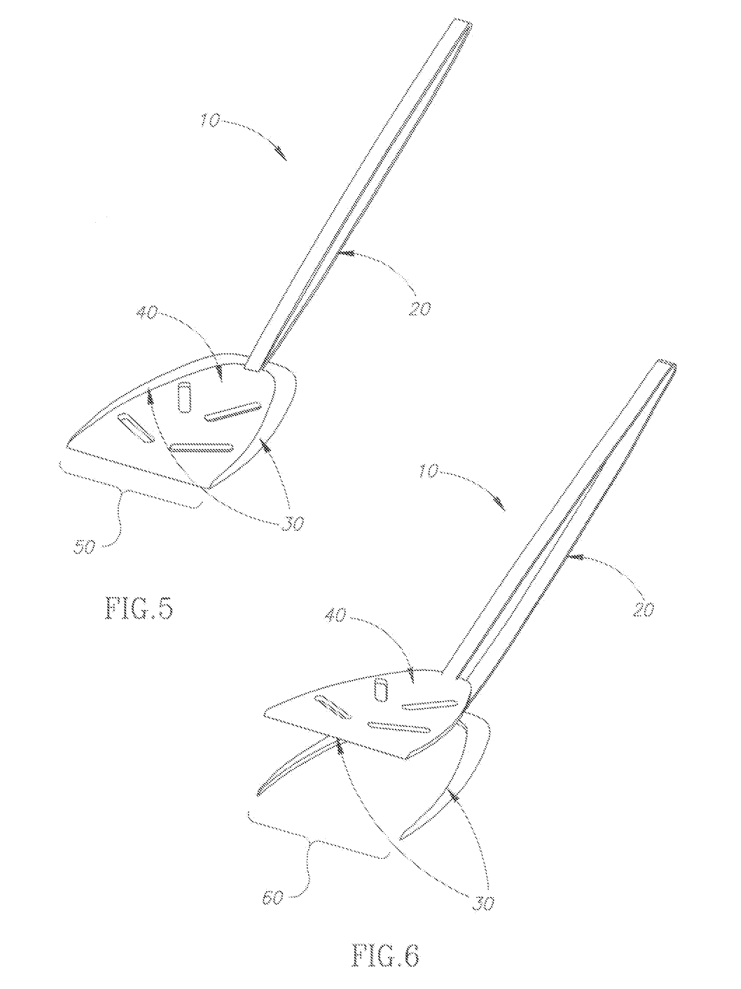

According to some embodiments, first branch 22 and second branch 24 may be flexibly joined at one end of handle 20 by means of, for example, springy material, a hinge, a spring, etc., as seen in FIGS. 5, 6, 7, and 8. According to some other embodiments, first branch 22 and second branch 24 may be flexibly joined in a manner resembling scissors, as seen in FIGS. 1, 2, 3, and 4. The pressure required to operate handle 20 may be small enough that multi function utensil 10 may be opened and closed easily. The closed and meshed position of utensil 10 may create the spatula tool 50 and the open and unmeshed position may create the tongs tool 70.

Handle 20 of multi-function utensil 10 may further provide a method for operating multifunction tool 10. According to some embodiments, wherein handle 20 is normally open, pressing together first branch 22 and second branch 24 may enable the use of tongs tool 70 and holding handle 20 closed may enable the use of spatula tool 50. According to some other embodiments, wherein handle 20 is normally closed, moving first branch 22 and second branch 24 apart may enable the use of tongs tool 70, and holding handle 20 open may enable the use of fork tool 60.

According to some embodiments, the second end of, for example, first branch 22 may terminate in at least two substantially acicular tines 30, as seen in FIGS. 1, 2, 3, 4, 5, and 6.

According to alternative embodiments of the invention, multi-function utensil 10 may have more than two tines 30. Tines 30 of some embodiments of multi-function utensil 10 may be less slender or may have another shape, for example, substantially dull. Tines 30 may be made of any materials suitable for using with consumable items, wherein such materials may include, for example, flexible silicon, stainless steel, plastic, etc.

According to some embodiments of multi-function utensil 10, the second end of, for example, second branch 24 may terminate in a spatula head 40 that may be substantially thin and flat. Some embodiments of multi-function utensil 10 may have a spatula head 40 with one or more slots or openings thereon. Spatula head 40 of some embodiments of multi-function utensil 10 may have one or more sharp edges. According to some embodiments, spatula head 40 may be flexible; in other embodiments, spatula head 40 may be substantially rigid. Spatula head 40 may be made of any heat-resistant material that is also suitable for using with consumable items, wherein such materials may include, for example, flexible silicon, stainless steel, plastic, etc.

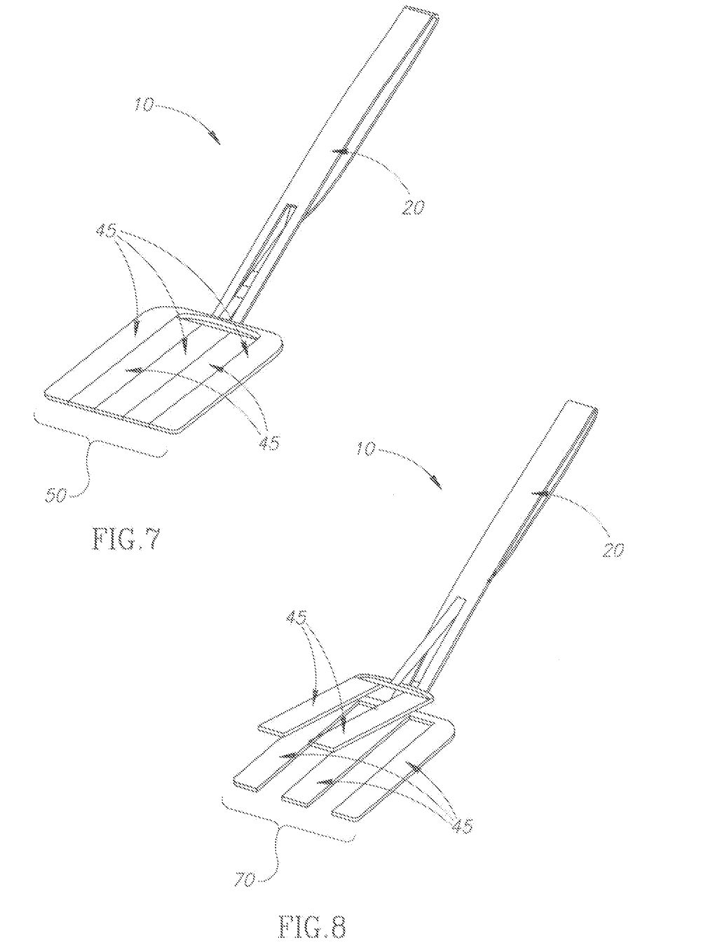

According to other embodiments, the second end of, for example, first branch 22 or second branch 24 or both may terminate in a plurality of substantially planar parallel strips 45, as seen in FIGS. 7 and 8 wherein parallel strips 45 of each branch 22 and 24 may, for example, be positioned such that when multi-function utensil 10 is in the closed position, a spatula tool 50 with a flat, regular surface may be created. Parallel strips 45 may be made of any heat-resistant material that may also be suitable for using with consumable items, wherein such materials may include, for example, flexible silicon, stainless steel, plastic, etc.

In some embodiments of the present invention, the ends of both first branch 22 and second branch 24 may terminate in spatula heads 40. In some embodiments of the present invention, the ends of both first branch 22 and second branch 24 may terminate in a plurality of tines 30, wherein tines 30 of each branch 22 and 24 may, for example, be positioned such that a spatula tool 50 with a flat, regular surface may be created when multi-function utensil 10 is in the closed position.

In order to more fully describe the present invention, the following describes three functions of multi-function utensil 10.

In the closed position, spatula head 40 sits snugly between tines 30, creating a substantially single-planed spatula tool 50 with a regular surface, as described in FIGS. 1, 5 and 7. When multi-function utensil 10 is in the closed position, this feature allows the user to easily slide spatula tool 50 of multi-function utensil 10 under an item that requires lifting.

In the opened, vertical position, handle 20 of multifunction utensil 10 is cupped in the user's hand 80 such that the flat upper side of handle 20 sits under the thumb 82, as shown in FIG. 2. Holding multi-function utensil 10 in this fashion, positions tines 30 and spatula head 40 in substantially vertical positions.

Additionally, spatula head 40 is separated from and positioned substantially above tines 30. This positioning is shown in FIGS. 2, 3, and 6. In this opened, vertical position, tines 30 may be used alone as a fork tool 60 for holding, lifting, or otherwise manipulating, for example, food.

By grasping handle 20 of multi-function utensil 10 in the hand 80 of the user such that tines 30 and spatula head 40 are substantially vertical, in the opened, horizontal position, multi-function utensil 10 may be used as a tongs tool 70.

Alternatively, said opened, horizontal positioning may be achieved holding multi-function utensil 10 in the afore described opened, vertical position, and rotating the user's hand 80, for example, approximately 90 degrees. The resulting positioning, shown in FIG. 4, may allow tines 30 to function together with spatula head 40 as the grasping jaws of a tongs tool 70. When functioning as a tongs tool 70, spatula head 40 may, for example, be placed under an object to must be moved, and tines 30 may be, for example, pressed on top of said object, thereby securely grasping said object and keeping it stable during transport.

According to other embodiments, in the closed position, parallel strips 45 of first branch 22 and parallel strips 45 of second branch 24 are interposed, creating a substantially single-planed spatula tool 50 with a regular surface, as described in FIG. 7. Accordingly, spatula tool 50 of such a multi-function utensil 10 may easily slide under an item that requires lifting. FIG. 8 describes such an embodiment in an open, horizontal position, wherein multi-function utensil 10 may be used as a tongs tool 70.

According to embodiments of the present invention, there is the option to integrate a locking mechanism into multi-function utensil 10, wherein said mechanism may lock handles in the open unmeshed position. Alternatively, the locking mechanism may lock a meshed closed position, which may facilitate storage and use of spatula tool 50.

Additionally, utensil 10 may further be attached to other cooking utensils such as a corkscrew, a knife and the like.

Additionally or alternatively, at least one of the parts of the multi function utensil 10 may be integrated with and/or designed as a razor or a knife enabling to cut and/or slice the edible products.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A multi-function cooking utensil that can be used as a spatula tool and as a tongs tool, said cooking utensil comprising two flexibly connected parts, wherein the shape of each part allows the two parts to mesh such that when said cooking utensil is in a meshed position, one part sits within the second part and the two parts combine into a single-planed spatula tool, wherein said utensil is used as a pair of tongs in an unmeshed position.

2. The utensil of claim 1 wherein said one part of said utensil is a fork tool comprising of at least two tines, wherein the integration of the two parts in a closed position create a spatula.

3. The utensil of claim 2 further comprising of a handle, wherein said handle is bifurcated, comprised of two elongated, relatively narrow first branch and second branch, wherein said handle terminates on one side in a spatula head connected to the first branch and on the other side in at least two tines connected to the second branch.

4. The utensil of claim 3 wherein said branches are flexibly joined composing the handle.

5. The utensil of claim 1 wherein said cooking utensil has three separate operating positions,
a. in a first, closed position, the utensil functions as a spatula,
b. in a second, open vertical position, the utensil functions as a fork, and
c. in a third, open horizontal position, the utensil functions as a pair of tongs.

6. The utensil of claim 1 has a spatula head with at least one opening thereon.

7. The utensil of claim 1 has a spatula head with at least one sharp edge.

8. The utensil of claim 2 wherein the first branch and second the second branch terminate in a plurality of substantially planar parallel strips, wherein said parallel strips are positioned such that when multi-function utensil is in the closed position, a spatula tool with a flat, regular surface is created.

9. The utensil of claim 8 wherein the parallel strips of the first branch and the parallel strips of the second branch are interposed, creating a substantially single-planed spatula tool in a closed position.

10. The utensil of claim 1 further including of a locking mechanism that enables to lock the handle in an open unmeshed position.

11. The utensil of claim 1 further including of a locking mechanism that enables to lock the handle in a closed meshed position.

12. The utensil of claim 1 further enables attaching to other cooking utensils.

13. The utensil of claim 1 wherein at least one of the parts of said utensil is designed as a razor.
